(19) United States
(12) Patent Application Publication
(10) Pub. No.: US 2005/0076106 A1
(43) Pub. Date: Apr. 7, 2005

(54) Asynchronous information retrieval

(76) Inventor: Jesse Hummer, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/667,485

(22) Filed: Sep. 23, 2003

(51) Int. Cl. G06F 15/173

(52) U.S. Cl. 709/223; 709/224

(57) ABSTRACT

A method for asynchronously retrieving information. Such a method may include: invoking a process in a subscribing server; registering, by the process, an event request with an event server; requesting, by the process over a first connection, resource information from a originating server, the first connection being disconnected after the requesting; receiving, by the event server over a second connection, event information from the originating server, the second connection disconnected after the receiving; and tranforming, to the process from the event server, the event information.

### BACKGROUND OF THE INVENTION

Client-server systems allow low end, less robust systems to access resources provided by more robust systems. Client-server systems are typically implemented using client and server software where client software resides on a low-end computing system such as a personal computer while the server software typically resides on a more robust, higher-end computing system. The client software and client software architecture are commonly referred to as “client” and “client framework”, respectively. The server software and server software architecture are commonly referred to as “server” and “server framework”, respectively.

FIG. 1 is an example block diagram of a typical client-server framework (again, also known as software architecture). The client-server framework architecture 100 of FIG. 1 generally is made up of a client framework 105 and a server framework 150.

The client framework 105 may be software residing on a computer platform that communicates with a server framework 150 typically located on another computing platform. The client framework 105 may reside on a personal computer (PC) or other computing device.

The server framework 150 may also be software loaded on a PC or other computing device. The server framework 150 communicates with the client framework 105 to allow the client framework 105 access to server components 180 provided by the server framework 150. The server framework 150 includes a server framework remote API 155, server framework manager 160, server components 180, and remote interfaces 175 as described below.

The server framework remote API 155 is used to set up a connection between the server framework 150 and client framework 105. The connection may be an RMI connection.

Each of the remote interfaces 175 of the server framework 150 is used to provide a communication path between the server component 180 and the client framework 105. The communication path may also be an RMI communication path.

Each server component 180 may be one or more software programs that are used by the client framework 105. Server components 180 may also be plug-in applications transferable for use by the client framework 105.

Typical uses of a client framework 105 and server framework 150 include client framework to server framework communications and server framework to server framework communications. Stand alone client frameworks often connect with a server framework as shown in FIG. 1 to establish client framework 105 to server framework 150 communications. However, it is also possible for two server frameworks to communicate with each by use of a client framework. To establish such a connection, a first server framework invokes a client framework which is then used to establish a connection with a remote server framework. In this scenario, the client framework acts on behalf of the first server framework when communicating with the remote server framework.

A characteristic of the typical client-server system, is that when a client framework requests information from a server framework, the client framework must maintain the connection with the server framework until the server framework provides the information requested. Maintaining such a connection can be problematic. Often, the client framework sits idle waiting for the server framework to retrieve information requested by the client framework. The longer it takes for a server framework to retrieve the requested information causes resources to be wasted on both sides of the client-server framework.

### SUMMARY OF THE INVENTION

An embodiment of the invention is directed to a method for asynchronously retrieving information. Such a method may include: invoking a process in a subscribing server; registering, by the process, an event request with an event server; requesting, by the process over a first connection, resource information from a originating server, the first connection being disconnected after the requesting; receiving, by the event server over a second connection, event information from the originating server, the second connection disconnected after the receiving; and transferring, to the process from the event server, the event information.

### BRIEF DESCRIPTION OF THE DRAWINGS

FIG. 1 is an example block diagram of a typical client-server framework architecture according to the background Art;

FIG. 2 is an example block diagram of server frameworks communicating with each other according to an embodiment of the invention;

FIG. 3 is an example of communications between two server frameworks according to an embodiment of the invention;

FIG. 4 is an example sequence diagram of a subscribe action according to an embodiment of the invention;

FIG. 5 is an example sequence diagram of event processing according to an embodiment of the invention;

FIG. 6 is an example sequence diagram of preparing for the forwarding of event information to a subscribing server framework according to an embodiment of the invention;

FIG. 7 is an example sequence diagram of preparing for the dispatch of the event information to a subscribing server framework according to an embodiment of the invention;

FIG. 8 is an example sequence diagram of the forwarding of event information according to an embodiment of the invention;

FIG. 9 is an example sequence diagram showing a connect and disconnect sequence for server framework 252 where a Shared J Core Connection is used according to an embodiment of the invention;

FIG. 10 is an example sequence diagram showing a connect and disconnect sequence for a server without a Shared J Core according to an embodiment of the invention; and.

FIG. 11 is an example sequence diagram showing an aging algorithm for the Thread: dispatcher Thread 760 according to the embodiment of the invention.

### DETAILED DESCRIPTION OF EXEMPLARY EMBODIMENTS

Additional features and advantages of the invention will be more fully apparent from the following detailed description of example embodiments, and the accompanying drawings.

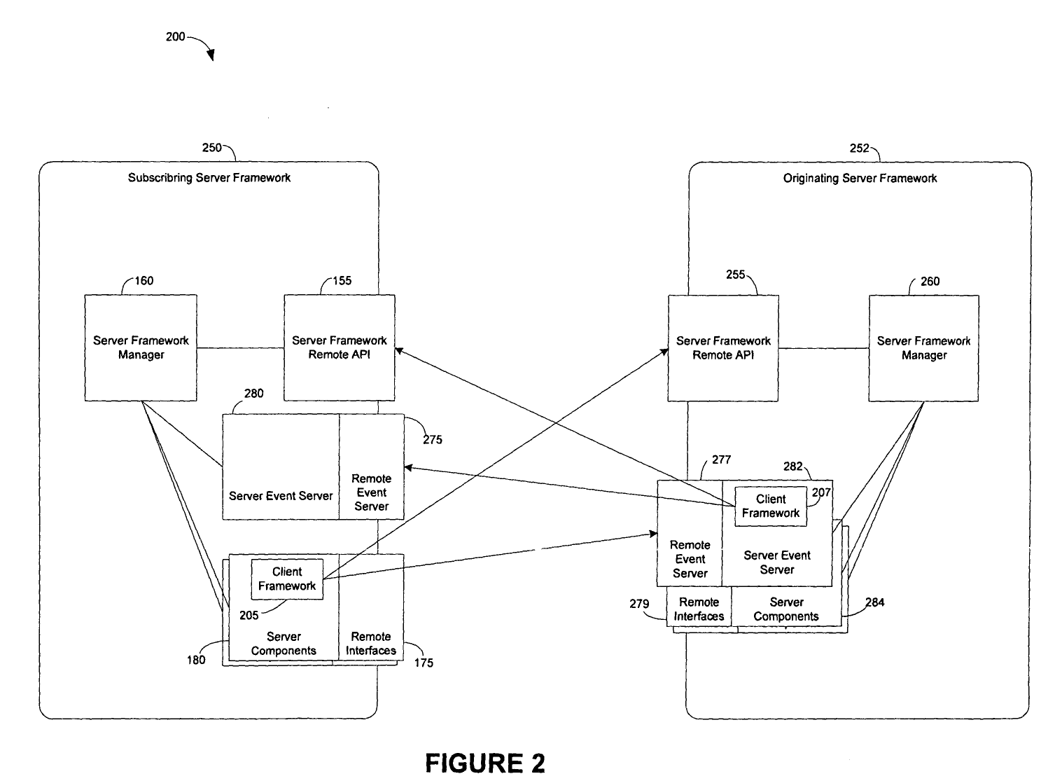

FIG. 2 is an example block diagram of server frameworks communicating with each other according to an embodiment of the invention.

Server communication system 200 shows two server frameworks, subscribing server framework 250 and originating server framework 252, with communication links between them.

Subscribing server framework 250 may be, for example, a storage manager. A storage manager may provide storage services to organizations and track usage of the storage services. A scenario of storage manager usage is that of a business client using at least one client framework 105 connected to the subscribing server framework 250 to access storage resources hosted by originating server framework 252. While the storage manager example is one example of a subscribing server framework that can be used in the server communication system 200, the server communication system 200 may be used in other circumstances where at least two server frameworks need to communicate with each other.

Subscribing server framework 250 is similar in some respects to server framework 150 except, e.g., that subscribing server framework 250 includes a server event server 280 for communicating, via the remote even server 275, with a server event server 282 of originating server framework 252. The server event server 280 is responsible for listening for and receiving events from another server event server 282 and for distributing events to server components 180 (listeners) that may be listening (waiting) for the events. An event is a data element reflecting an occurrence of an action that is processed by an application layer process.

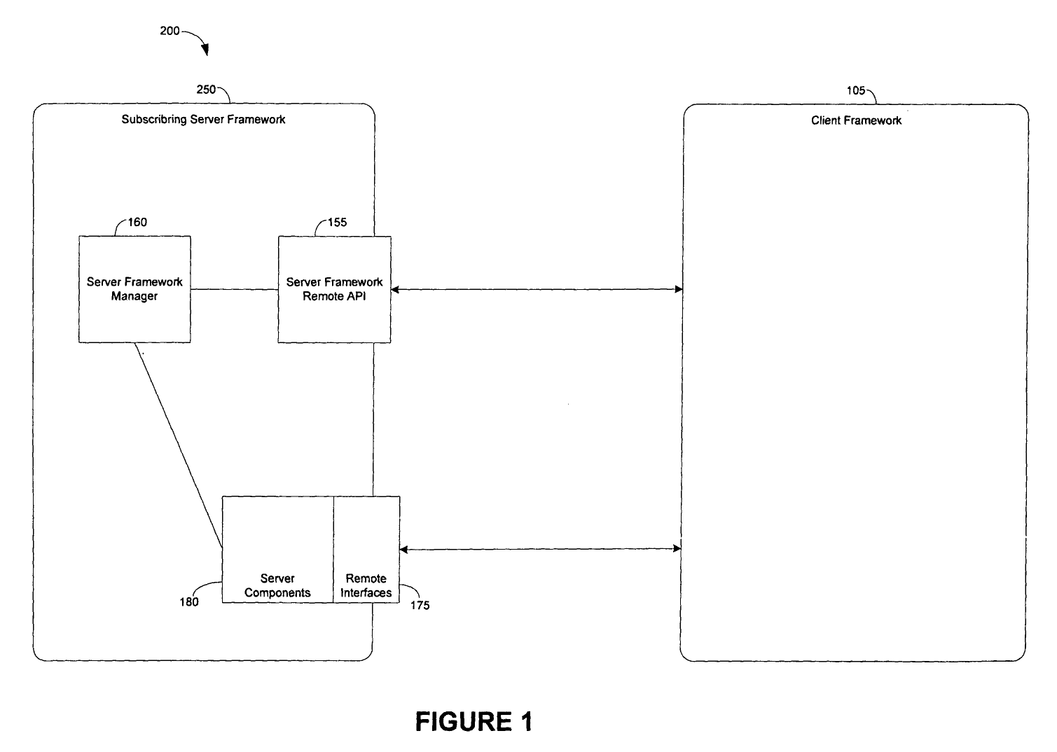

Originating server framework 252 is a server framework that may reside on a computing system such as a PC or higher end computing device. The originating server framework is similar in some respects to the server framework 150, except, e.g., that the originating server framework 252 includes a server event server 282. The originating server framework 252 may be used to host resources used by subscribing server framework 250. For example, storage devices may be associated with originating server framework 252 that are needed by subscribing server framework 250. Using the connection between the subscribing server framework 250 and originating server framework 252 via the remote event server 277, subscribing server framework 250 may access and utilize the resources/server components 284 residing in the originating server framework 252 to obtain event information. The remote interfaces 279, server framework remote API 255, and server framework manager 260, perform similar operations as their like named counter parts in FIG. 1.

The server event server 282 is responsible for listening for subscription requests, described later on, from other server frameworks such as subscribing server framework 250, and for forwarding events to server frameworks according to their subscriptions. An event may be a computer instruction to carry out a computing related operation. The listeners may reside in a server framework or a client framework. The server event server 282 may also be responsible for forwarding or dispatching event requests.

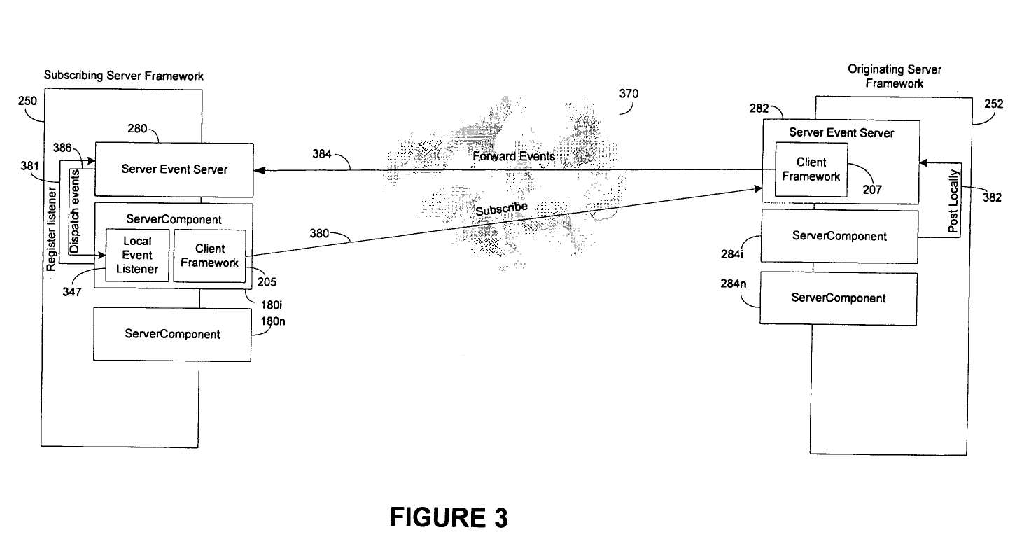

For communications between subscribing server framework 250 and originating server framework 252, client frameworks are required as shown by client framework 205 and client framework 207, respectively. Communication between the subscribing server framework 250 and the originating server framework 252 are shown as arrows between the two server frameworks 250, 252. More detail of communications is provided in FIG. 3.

FIG. 3 is an example of communications between two server frameworks according to an embodiment of the invention.

In FIG. 3, subscribing server framework 250 subscribes through a network 370 for specific events to be forwarded from originating server framework 252. The event initially occurs in originating server framework 252 and is forwarded to subscribing server framework 250 according to its subscription. The event is then dispatched to all registered listeners on subscribing server framework 250 as if the event occurred locally.

In this configuration, the subscribing server framework 250 includes the subscribing server event server 280 and server components 180ᵢ-180ₙ. The originating server framework 252 includes the server event server 282 and server components 284ᵢ-284ₙ. The server event server 282 is a server component 284 configured to perform server event server functions.

In FIG. 3, for a scenario where a server component 180ᵢ in subscribing server framework 250 wants to have certain events forwarded from originating server framework 252, the server component 180ᵢ first registers (arrow 381) a local event listener 347 with the server event server 280, makes a client framework 205 connection to originating server framework 252, acquires the server event server 282 remote interface, then issues a subscribe command (arrow 380) containing the event information and the subscribing server framework 280 connection information. After the subscribe command (arrow 380) is given to originating server framework 252, the connection is then terminated. When a server component 284ᵢ event occurs, the event is posted (arrow 382) locally to server event server 282. Server event server 282 forwards (arrow 384) the event to subscribing server event server 280 according to the prior event subscription over another connection to the subscribing server framework 250. After the server event server 282 forwards (arrow 384) the event to the subscribing server event server 280, the connection is then terminated. Subscribing server event server 280 then dispatches (arrow 386) the event information to the local event listener 347 in the server component 180ᵢ according to the prior local event listener registration.

The server component 180ᵢ includes a local event listener 347. The local event listener 347 is an object of the server component 180ᵢ that is registered (arrow 381) with the subscribing server event server 280 to be notified when a certain type of event occurs locally on the subscribing server framework 250.

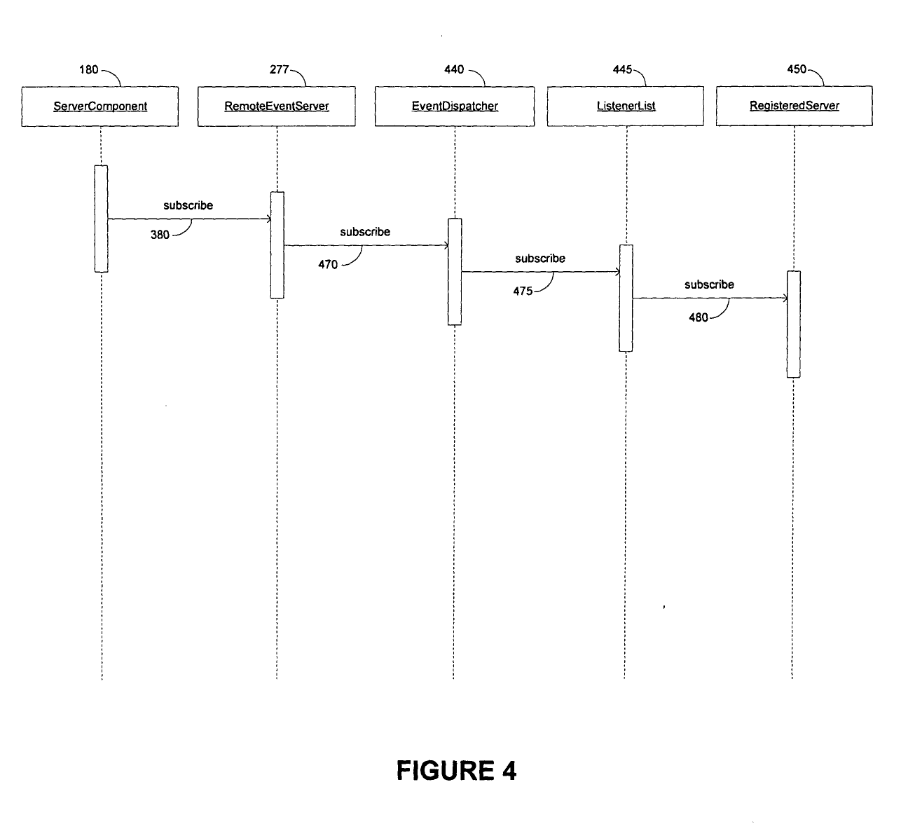

The operation of FIG. 3 is further described with reference to FIGS. 4-11.

FIG. 4. is an example sequence diagram of a subscribe action according to an embodiment of the invention. The sequence diagram is in accordance with the Unified Modeling Language (UML) instructions. In UML sequence drawings. Messages are depicted with arrows of different styles. A → indicates a message that expects a response message. A ← indicates a response message. A → indicates a message for which the response is implied. And a [symbol] indicates a message for which no response is expected.

Again, when a server component 180 of subscribing server framework 250 wants to have certain events forwarded from originating server framework 252, server component 180 must register a listener locally and subscribe remotely to the server event server 282 of the originating server framework 252. In more detail, after registering a local event listener 347 with the server event server 280 of the subscribing server framework 250, server component 180ᵢ makes a client connection to originating server framework 252 and obtains the remote interface (remote event server 277) of server event server 282. Server component 180 then issues a subscribe command to RemoteEventServer 277 as shown by arrow 380 in FIG. 4. The subscribe message 380 can include service descriptor information, category of event and ID of event. The service descriptor information includes information that describes how to connect back to the subscribing server framework. The category of event includes information regarding the type of event being requested. The ID of event is a value assigned to a particular event so that information related to a particular category of event may be more readily tracked for computing purposes.

The remote event server 277 is an object of the server event server 282. The remote event server 277 receives remote subscription requests for the server event server 282.

After remote event server 277 receives subscribe information it passes on the subscribe information to an event dispatcher 440 as shown by arrow 470. The event dispatcher 440 is an object of the server event server 282 that is responsible for dispatching events locally to listeners, remote dispatching to a client that has registered a remote listener, and correspondingly forwarding to those that have subscribed with the originating server framework 252 for the event information.

Upon receiving the subscribe message, the event dispatcher 440 determines whether a listener list 445 has been created for a category (to be discussed below) associated with the subscribe information. If a listener list 445 does not exist, the event dispatcher 440 creates a listener list 445 for the category. The listener list 445 is an object of the event dispatcher 440 that includes a listing of all listeners that have been registered to be notified of events associated with the listener list 445.

Each event is associated with a category. A category is a label used for general grouping of similar events. Event listeners are registered by category so that they are only notified of events belonging to that category. For a particular event dispatcher 440, there may be many listener lists 445 but there should be only one listener list 445 per category.

The event dispatcher 440 passes subscribe information on to the listener list 445 associated with the category in the subscribe information as shown by arrow 475.

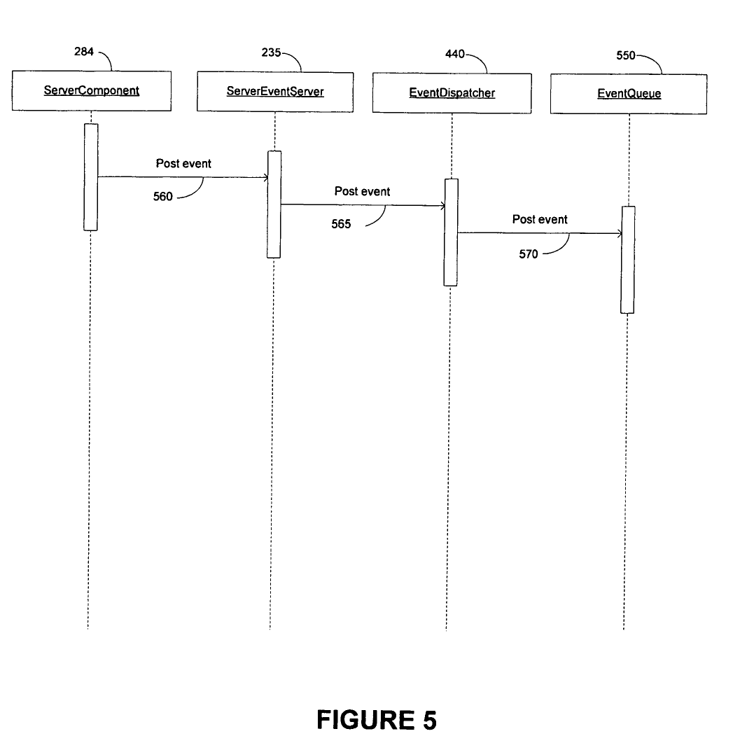

As shown by arrow 480, the listener list 445 sends subscribe information to a subscribing server framework 250 object. The subscribing server framework 250 object is an object of the listener list 445 that receives the subscribe information and extracts information regarding a server (service descriptor) and registers and maintains information about a subscribing server framework. A subscribing server framework becomes registered once it is made known to the subscribing server framework 250 object through the subscribe activity. Once the subscribing server framework becomes registered, the originating server framework processes the event posting as shown in FIG. 5 below.

FIG. 5 is an example sequence diagram of event posting according to an embodiment of the invention.

As shown by arrow 560, event information is generated by and passed from one of the server component 284ᵢ to the server event server 282. It is the result of the server component 284ᵢ performing an action and an event resulting from the action. The event information can include the category of the event, the ID of the event, and the event payload. The event payload may be data related to an event.

As shown by arrow 565, the server event server 282 passes the event information on to the event dispatcher 440 which prepares the event information for dispatching. As shown by arrow 570, the event dispatcher 440 passes event information on to an event queue 550. The event queue 550 is an object that may be a part of the event dispatcher object 440. The event queue 550 acts as a buffer to assist in the dispatching and posting of events.

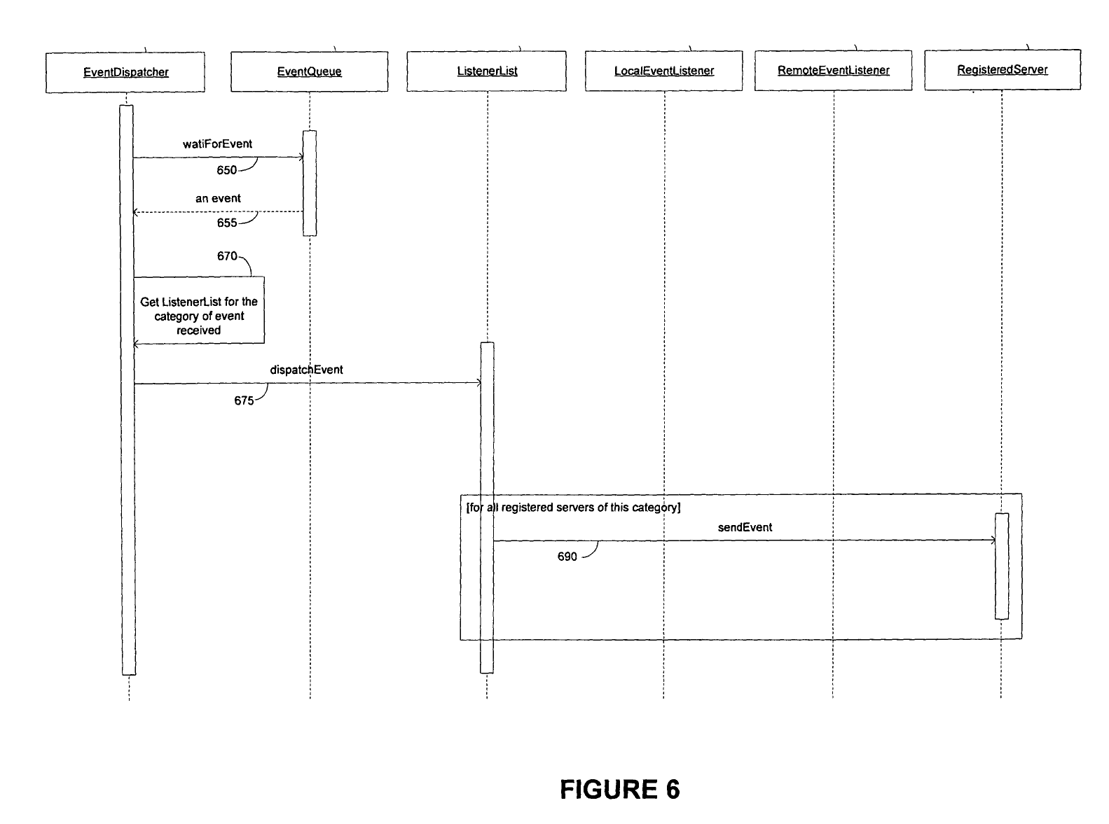

FIG. 6 is an example sequence diagram of preparing for the forwarding of event information to a subscribing server framework according to an embodiment of the invention.

As shown by arrow 650, the event dispatcher 440 waits for an event to occur by querying the event queue 550. As shown by arrow 655, the event queue 550 provides event information to the event dispatcher 440 when event information is present and the event dispatcher 440 is able to receive the information.

As shown by arrow 670, the event dispatcher then retrieves the category information from the event information and determines which listener list 445 is applicable by matching the category information of the event with the category information of the listener list 445. If no listener list 445 exists for the category of the event, the event may not be further processed.

As shown by arrow 675, the event dispatcher then dispatches the event to the listener list 445 by sending a dispatch event message including event information to the listener list 445. As shown by arrow 690, the listener list 445 sends event information to the registered server object 450. While arrow 690 shows event information going to the registered server 450 object, other recipients may also be a remote event listener or a local event listener.

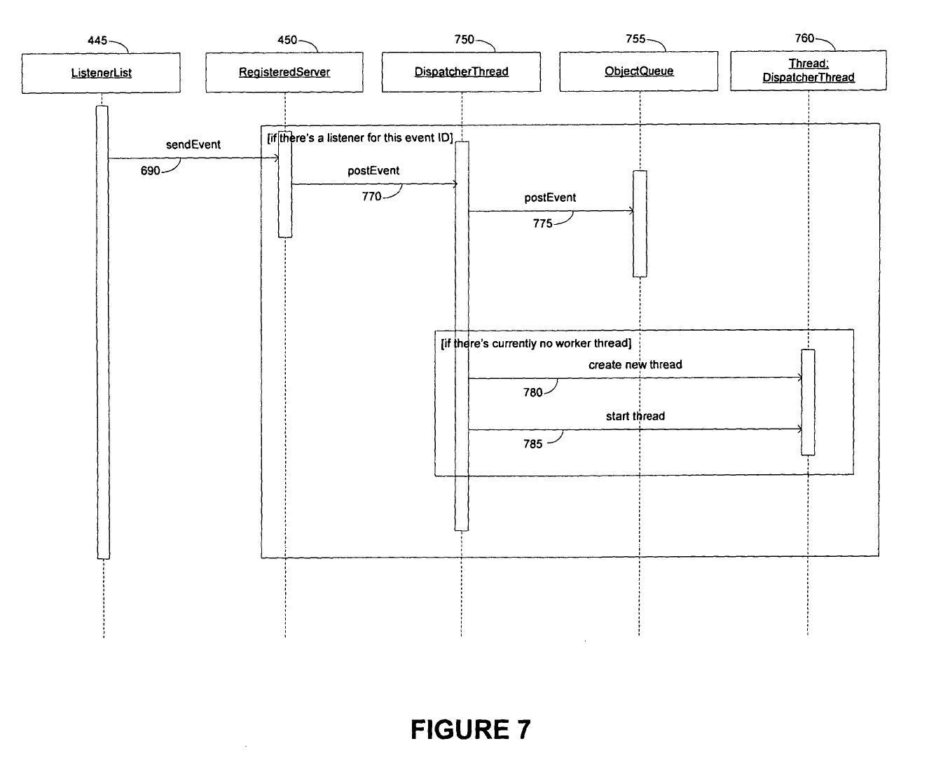

FIG. 7 is an example sequence diagram of preparing for the dispatch of the event information to a subscribing server framework according to an embodiment of the invention.

After the send-event message 690 including event information is sent to the registered server 450 object. The registered server 450 object determines if there is a listener for the event ID of the event information in the message 690.

As shown by arrow 770, a post event message is sent from the registered server 450 object to a dispatcher thread 750. The dispatcher thread 750 is part of the originating server framework 252. It is responsible for calling back the subscribing server framework 250 associated with the registered server 450 object. The post-event message includes the server information provided by the subscribing server framework 250 object and the event information.

As shown by arrow 775, a dispatch message including post-event message information is sent to an object queue 755. The object queue 755 acts as a queue to hold information prior to the event being forwarded to the subscribing entity (e.g., subscribing server framework 250). This frees up the event dispatcher 440 so it may process more events for forwarding in the forwarding procedure.

As shown by arrow 780, the dispatcher thread creates a thread: dispatcher thread 760 if one does not exist. The thread: dispatcher thread 760 is a thread that is used to forward event information to the subscribing server framework 250.

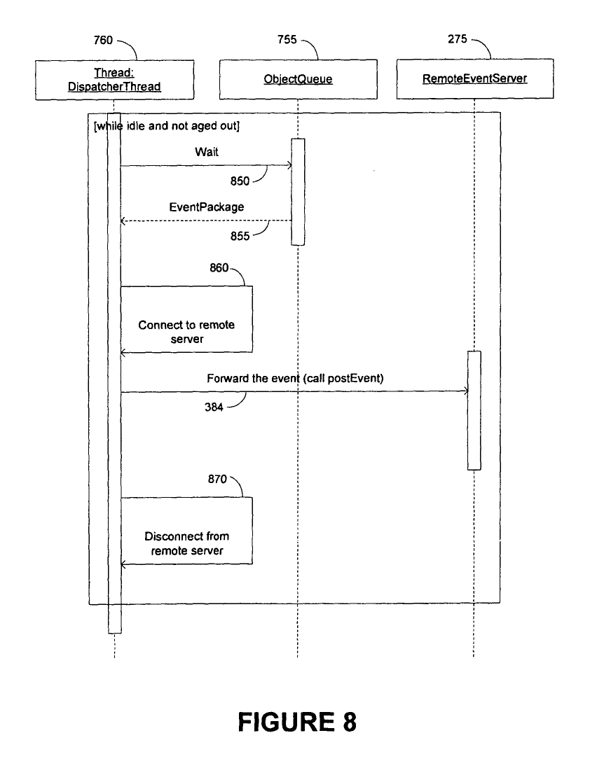

As shown by arrow 785, the thread: dispatcher thread 760 receives a command to commence from the dispatcher thread 750. Further operation of the thread: dispatcher thread 760 is described with reference to FIG. 8.

FIG. 8 is an example sequence diagram of the forwarding of event information according to an embodiment of the invention.

As shown by arrow 850, the thread dispatcher thread 760 waits for event information to arrive in the object queue 755. As shown by arrow 855, the thread dispatcher thread 760 retrieves the event information from the object queue 755 after the event information arrives in the object queue 755. The Thread DispatcherThread 760 then connects (arrow 860) to a remote server.

As shown by arrow 384, the thread dispatcher thread 760 issues a post event command, including event information, to a remote event server 275. The remote event server 275 is the portion of the subscribing server event server 280 of the subscribing server framework 250 that receives the forwarded event message. In doing this, the Thread dispatcher thread 760 establishes a client connection with the subscribing server framework 250, obtains the remote interface (remote event server 275) of the subscribing server event server 280, and forwards the event message to the subscribing server event server 280. After the event message is sent from the originating server framework 252, the client connection may be disconnected (arrow 870).

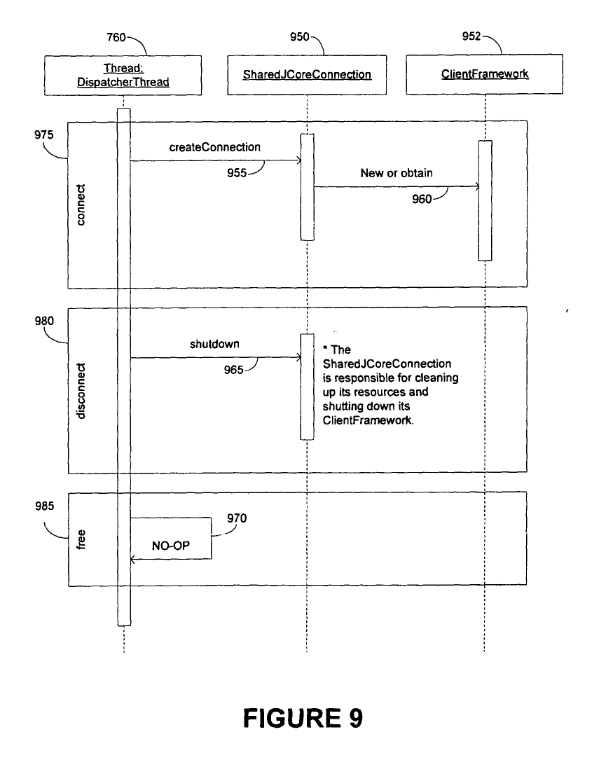

FIG. 9 is an example sequence diagram showing a connect and disconnect sequence for server framework 252 where a Shared J Core Connection is used according to an embodiment of the invention.

Block 975 shows the connect sequence when using shared J Core connections. This occurs within the originating server framework 252 to setup a client connection from the originating server framework 252 to the subscribing server framework 250.

As shown by arrow 955, a create connection command message including service descriptor information is sent to a Shared J Core Connection object 950. The Shared J Core Connection object 950 determines the server framework by which to establish a communication and determines whether a client framework 207 exists. If the client framework 207 does not exist, the Shared J Core Connection object 950 creates a client framework 207 as shown by arrow 960. The client framework 207 object is a part of the originating server framework 252 that is used to communicate with subscribing server framework 250.

Block 980 shows the disconnect sequence when using shared J Core connections. J Core connections are java related connections. They are sophisticated connections that have programmable policies associated with them for starting up and shutting down the connection. Arrow 965 shows a sequence that occurs within the originating server framework 252 to disconnect a connection between originating server framework 252 and subscribing server framework 250. A disconnect occurs after an event has been sent to subscribing server framework 250.

As shown by 965, a shutdown command is sent to the Shared J Core Connection object 950. The shared J Core connection is then shut down. In shutting down, the shared J Core connection may clean up its resources and shut down the client framework 207. The actual shutdown of the client framework 207 and resource clean up within the shared J Core connection may occur immediately after (or a predetermined time after) the shared J Core connection shutdown is invoked, or may occur according to another aging algorithm.

Block 985 shows the free sequence when using shared J Core connections. Since the shared J Core connection is fully responsible for freeing up resources once it has been shutdown, arrow 970 shows that no operation is required by the thread: dispatcher thread 760 in this case.

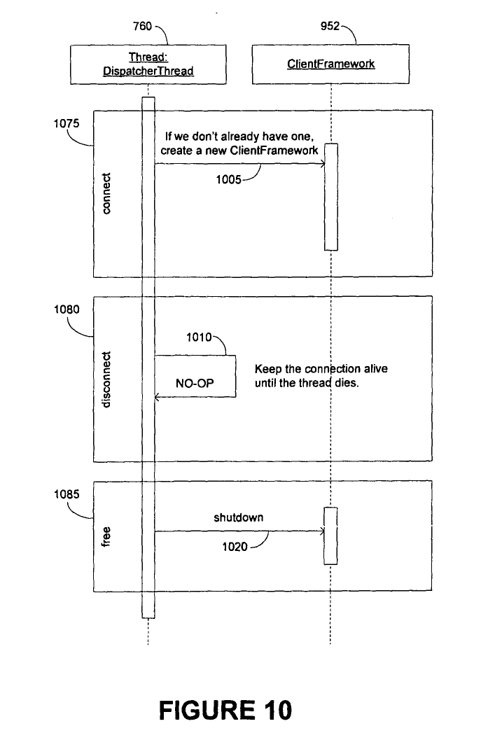

FIG. 10 is an example sequence diagram showing a connect, disconnect, and free sequence for a server without a shared J Core connection according to an embodiment of the invention.

Block 1075 shows an alternative connect sequence when a shared J Core connection functionality is not available. Older versions of Java do not support J Core routines. In these cases an alternative to J Core is used to connect and disconnect. This alternative to a shared J Core connection occurs within the originating server framework 252 to setup a client connection from the originating server framework 252 to the subscribing server framework 250.

As shown by arrow 1005, a new client framework 207 is created using the service descriptor information if the client framework 207 does not yet exists. If the client framework 207 does exist, the Thread: dispatcher thread 760 uses the existing client framework 207. The client framework 207 object is a part of the originating server framework 252 that is used to communicate with subscribing server framework 250.

Block 1080 shows a disconnect sequence when shared J Core connection functionality is not available. Arrow 1010 shows a sequence that occurs within the originating server framework 252 to disconnect a connection between originating server framework 252 and subscribing server framework 250. A disconnect occurs after an event has been sent to subscribing server framework 250. As a predictive measure that this client framework 207 may be re-used in the near future, no operation is taken (arrow 1010) and the shutdown for client framework 2 07 i s differed until the free procedure (described later) In this state, the thread: dispatcher thread 760 keeps the connection alive between originating server framework 252 and subscribing server framework 250 until the thread: dispatcher thread 760 is about to die.

Block 1085 shows the free sequence when shared J Core connection functionality is not available. Immediately before the thread: dispatcher thread 760 is about to die, arrow 1020 shows the Thread: dispatcher Thread 760 sending a shutdown command to the client framework 207. The client framework 207, after receiving the shutdown command 1020, shuts itself down by closing the connection and releasing its resources. This frees up memory by removing an instance of the client framework 207 during periods of inactivity.

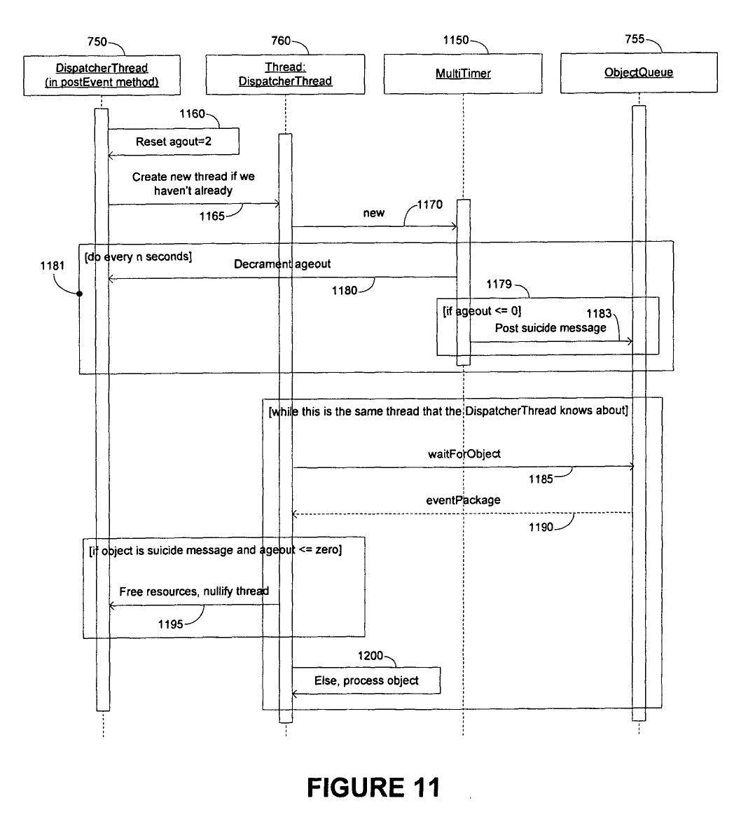

FIG. 11 is an example sequence diagram showing an aging algorithm for the thread: dispatcher thread 760 according to an embodiment of the invention.

Initially, a variable, e.g., in this case “ageout”, is set (e.g. equal to 2) by the dispatcher thread 750 as shown by arrow 1160. The dispatcher thread 750 then creates a new object known as thread: dispatcher thread 760 if one hasn't been created, as shown by arrow 1165. The thread dispatcher thread 760 then creates a multitimer 1150 that assists in the aging of the Thread: dispatcher Thread 760 by executing itself once every perdetermined period. The multitimer 1150 sends a message to the dispatcher thread 750 to decrement the ageout variable as shown by arrow 1180. The multitimer then 1150 checks if the current value of ageout is less than or equal to a reference value, e.g., zero, as shown by block 1179. If not, the multitimer 1150 takes no further action until its next period. But if so, then the multitimer 1150 posts a suicide message to the object queue 755 as shown by arrow 1183. Block 1181 represents a loop that repeats over a predetermined period.

While the thread: dispatcher thread 760 is still alive, the thread: dispatcher thread 760 waits for an object to enter the object queue 755 that is associated with the thread: dispatcher thread 760 as shown by arrow 1185. When either event information or a suicide message is available in the object queue 755, the event information (see arrow 775) or suicide message (see arrow 1183) is sent to the thread: dispatcher thread 760 as shown by arrow 1190. If the suicide message has been received by the thread: dispatcher thread 760, dispatcher thread 760 resources are freed and the thread: dispatcher thread 760 is nullified. Otherwise, the thread: dispatcher thread 760 processes the event information by sending it to the remote event server 275 of the subscribing server framework 250 as seen in FIG. 8.

Once the remote event server 275 of the subscribing server framework 250 receives the requested event information from the originating server framework 252, it dispatches the event information to all of it's registered listeners.

Embodiments of the present invention provide (among other things): a subscribing server framework 250 to asynchronously request (subscribe) for information from an originating server framework 252. This is advantageous because it allows a subscribing server framework 250 to accomplish other tasks while waiting for event information from an originating server framework 252. This is accomplished by asynchronous client-server connections between the server frameworks 250, 252. In large scale networked systems where originating server frameworks are providing event information to numerous subscribing server frameworks, the asynchronous client-server connections are also advantageous because the subscribing server frameworks need not stay connected to the originating server framework while waiting for event information. This allows connection resources to be freed upon the originating server framework. Which in turn, provides the originating server framework with greater capacity to handle more subscribing server frameworks.

Although the embodiments described above in connection with the present invention are particularly useful in computing server systems, they may also be utilized in any other communication system, as would be known to one of ordinary skill in the art.

Further, while the subscribing server framework and originating server framework are shown as residing on two separate computing machines, each computing machine may have both an originating server framework and subscribing server framework residing on it. Moreover, where only two server frameworks are shown communicating with each other, other implementations may include the networking of multiple server frameworks communicating with each other.

It is noted that the functional blocks in the exemplary embodiments of FIGS. 1-11 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s) either with or without carrier wave(s).

This specification describes various example embodiments of the method and system of the present invention. The scope intended to cover various modifications and equivalent arrangements of the illustrative embodiments disclosed in this specification.

1. A method for asynchronously retrieving information comprising:
invoking a process in a subscribing server;
registering, by the process, an event request with an event server;
requesting, by the process over a first connection, resource information from a originating server, the first connection being disconnected after the requesting;
receiving, by the event server over a second connection, event information from the originating server, the second connection disconnected after the receiving; and
transferring, to the process from the event server, the event information.

2. The method of claim 1 further comprising:
listening by the process to the event server for the availability of the event information.

3. The method of claim 1 further comprising:
categorizing an event request into an event type to aid in the processing of the request.

4. The method of claim 1 wherein,
the first and second connections occur over remote method invocation connections.

5. A system for asynchronously retrieving information comprising:
means for invoking a process in a subscribing server;
means for registering by the process an event request with an event server;
means for requesting by the process, over a first connection, event information from an originating server;
means for disconnecting the first connection after requesting the event information;
means for receiving by the event server, over a second connection, the event information from the originating server;
means for disconnecting the second connection after receiving the event information; and
means for transferring to the process from the event server, the event information.

6. The system of claim 5 further comprising:
means for listening by the process to the event server for the availability of the event information;

7. The system of claim 5 further comprising:
means for categorizing an event request into an event type to aid in the processing of the request.

8. The system of claim 5 further comprising:
means for connecting the process to the originating server using a remote method invocation connection.

9. The system of claim 5 further comprising:
means for assigning an identification value to the event request.

10. A system for asynchronously retrieving information comprising:
an originating server;
a subscribing server that invokes a process wherein the process registers an event request with an event server of the subscribing server; the process further requests resource information from the originating server using a first connection; the event server receives event information from the originating server using a second connection, and transfers to the process the event information, the first connection and the second connection being terminated after an event is registered and event information is transferred, respectively.

11. The system of claim 10 further comprising wherein the process listens to the event server for the availability of the event information;

12. The system of claim 10 wherein the subscribing server further categorizes an event request into an event type to aid in the processing of the request.

13. The system of claim 10 wherein the subscribing server further connects the process to the originating server using a remote method invocation connection.

14. The system of claim 10 wherein the subscribing server further assigns an identification value to the event request.

15 A machine readable medium including instructions that instruct a computing device, the instructions comprising:
invoking a process in a subscribing server;
registering, by the process, an event request with an event server;
requesting, by the process over a first connection, event information from a originating server, the first connection being disconnected after the requesting;
receiving, by the event server over a second connection, event information from the originating server, the second connection being disconnected after the receiving; and
transferring to the process from the event server, the event information.

16. The instructions of claim 15 further comprising:
listening by the process to the event server for the availability of the event information;

17. The instructions of claim 15 further comprising:
categorizing an event request into an event type to aid in the processing of the request.

18. The instructions of claim 15 further comprising:
connecting the process to the originating server using a remote method invocation connection.

19. The instructions of claim 15 further comprising:
assigning an identification value to the event request.

20. A system for asynchronously retrieving information comprising:
a subscribing server,
a originating server that uses an event server to receive and handle an event request over a first connection from the subscribing server, transfers event information from a process to the event server, and forwards over a second connection the event information to the subscribing server via the event server.

21. A method of asynchronously retrieving information comprising:
receiving, by a first server, a request for a event information from a client;
sending a request over a first connection to a second server to provide the resource, the first connection being disconnected after the sending;
receiving from the second server, over a second connection, event information, the second connection being disconnected after the receiving;
sending a portion of the resource event information to the client.
